(19) United States
(12) Patent Application Publication
(10) Pub. No.: US 2016/0230540 A1
(43) Pub. Date: Aug. 11, 2016

(54) DETERMINING WELL FLUID FLOW VELOCITY BASED ON VORTEX FREQUENCY

(71) Applicant: HALLIBURTON ENERGY SERVICES, INC., Houston, TX (US)

(72) Inventors: Liang Zhao, Plano, TX (US); Michael Linley Fripp, Dallas, TX (US); Zachary Ryan Murphree, Dallas, TX (US); Thomas Jules Frosell, Irving, TX (US)

(21) Appl. No.: 15/022,068

(22) PCT Filed: Oct. 14, 2013
(86) PCT No.: PCT/US2013/064854

§ 371 Date: Mar. 15, 2016

(51) Int. Cl. E21B 47/10; G01F 1/46; G01F 1/32

(52) U.S. Cl. CPC E21B 47/10; G01F 1/32; G01F 1/46

(57) ABSTRACT

One example of determining well fluid flow velocity based on vortex frequency is implemented using a well fluid flow velocity measurement system. The system includes a well fluid flow monitoring unit to determine a parameter of a well fluid flow in response to a vortex being produced in a well fluid, and provide the parameter. The system also includes a controller to receive the parameter determined by the flow monitoring unit, determine a frequency of the vortex from the received parameter, and determine a flow velocity of the well fluid based on the determined frequency.

### TECHNICAL FIELD

This disclosure relates to determining well fluid flow velocity.

### BACKGROUND

Extraction of natural resources, e.g., hydrocarbons, natural gas, and other natural resources, involves forming a well by drilling a hole through a subterranean formation (or formations). While a drill bit is operated to drill the well, drilling fluid (or drilling mud) is flowed through the hole to perform one or more of several operations including, e.g., maintaining a hydrostatic pressure to prevent formation fluids from entering into the well, to keep the drill bit cool and clean, to carry out drill cuttings, to suspend drill cuttings while drilling is paused and other operations. One of the factors that affect the ability of the drilling fluid to perform these operations is a velocity with which the drilling fluid flows into and out of the well. Checking the return flow velocity can enable determining/confirming that there is no major fluid loss. The fluid flow velocity is affected by factors such as fluid properties (e.g., viscosity, density, and other properties), pressure, well dimensions, sizes and shapes of cuttings carried by the fluid, and other factors. Monitoring a flow velocity of the drilling fluid is, consequently, beneficial for improved well drilling operations.

### DESCRIPTION OF DRAWINGS

FIG. 1 illustrates an example well fluid flow velocity measurement system.

FIG. 2 is a flowchart of a process for determining well fluid flow velocity.

FIGS. 3A and 3B illustrate example structures included in a flow monitoring unit of the well fluid flow velocity measurement system of FIG. 1.

Like reference symbols in the various drawings indicate like elements.

### DETAILED DESCRIPTION

This disclosure relates to determining well fluid flow velocity based on a vortex frequency, i.e., a frequency at which a vortex is shed. Flowmeters that can be used to measure well fluid flow velocity include venturi-type flowmeters and vortex shedding flowmeters. Well fluids, e.g., drilling fluids, are often used in hostile operating conditions, e.g., at high pressures and temperatures in the well. Well fluids sometimes contain chemicals or content (e.g., solid content such as drill cuttings) that can be abrasive or otherwise harmful to components that contact the well fluids. Implementing certain flowmeters, e.g., venturi-type flowmeters, in such hostile conditions to determine well fluid flow velocity can negatively affect the performance of the flowmeters. For example, a flowmeter that operates using rotating parts can be clogged by the drill cuttings that are carried by the drilling fluid. Alternatively or in addition, the components of the flowmeter may not function to measure flow velocity under the high pressures and temperatures in the well. Also, components of the flowmeter can erode due to the chemicals or the content contained in the well fluid.

This disclosure describes measuring well fluid flow velocity by implementing a system that operates by determining a frequency at which vortices generated in a well fluid are shed. As described in this disclosure, vortices are generated in a well fluid using a structure, e.g., a bluff body, positioned in a well fluid flow path. For example, the structure can be a solid cylinder positioned in a direction relative to the well fluid flow path, e.g., transverse to the well fluid flow path. Other structures could additionally or alternatively be used. When the structure is positioned in the fluid flow path, vortices are generated at positions on the structure. As the fluid flow velocity increases, the vortices are shed at downstream positions. The shedding of vortices affects well fluid parameters or other physical parameters in the well fluid flow path. For example, a well fluid flow parameter such as pressure at downstream position is affected by, i.e., changes in response to, a vortex flowing past the downstream position being shed. Alternatively or in addition, a physical parameter such as a force applied by the flowing well fluid on a structure in the well fluid flow path, e.g., the structure that generates the vortex, is affected by, i.e., changes in response to, the well fluid flowing past the structure. As described below, well fluid parameters or other physical parameters that are affected by a vortex generation are measured using, e.g., appropriate sensor (or sensors) positioned in a well fluid flow path at appropriate positions in the well fluid (e.g., downstream of the vortex generating structure, at the vortex generating structure, or other positions in the well fluid flow path at which the vortex is generated.

Such a system can be implemented as a simple, yet accurate system to measure well fluid flow velocity. The system can include components that can operate despite the hostile environments that well fluids experience. For example, the system can be designed to withstand and operate under high temperatures and pressures of the well without being affected by the chemicals in the well fluid before and after flowing through the well. Also, the system need not include any moving parts thereby decreasing or avoiding the possibility of particulate or drilling mud breaking down the system by lodging into the moving parts. The system can be sealed to avoid intrusion of drilling mud or chemicals in the mud and the associated wear. As described below, the system can also be designed to measure well fluid flow velocity despite the high and often variable densities of the well fluid with or without solid contents (e.g., drill cuttings). The system can be implemented outside the well, e.g., at the surface, or in the well (or at both locations).

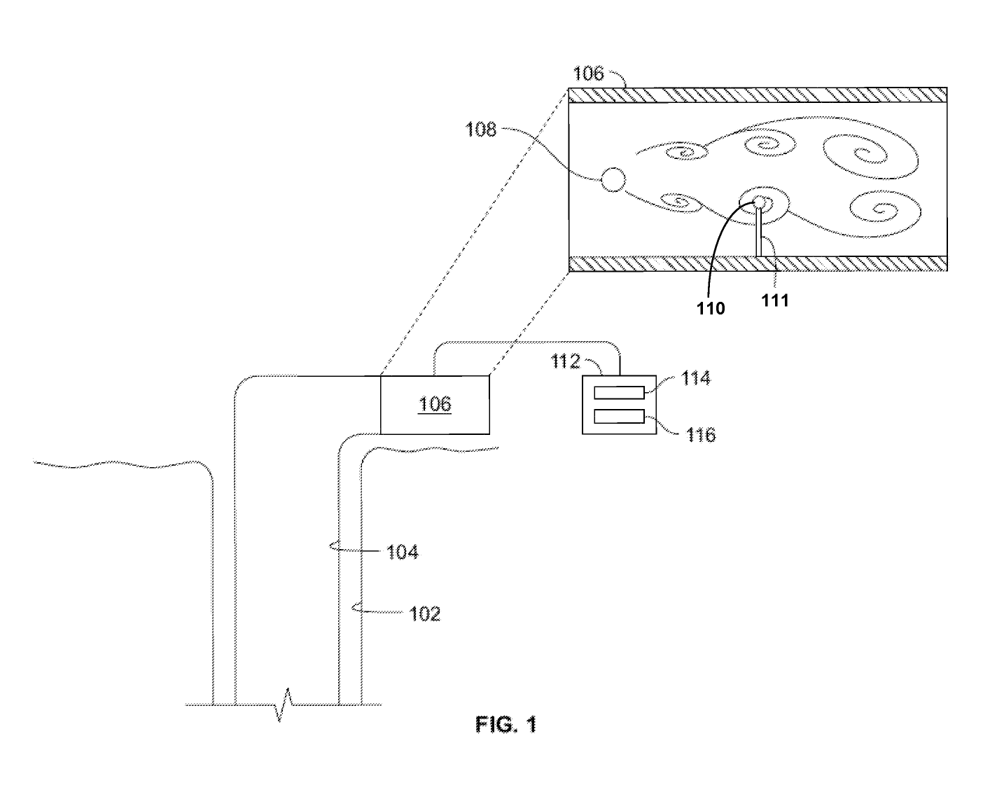

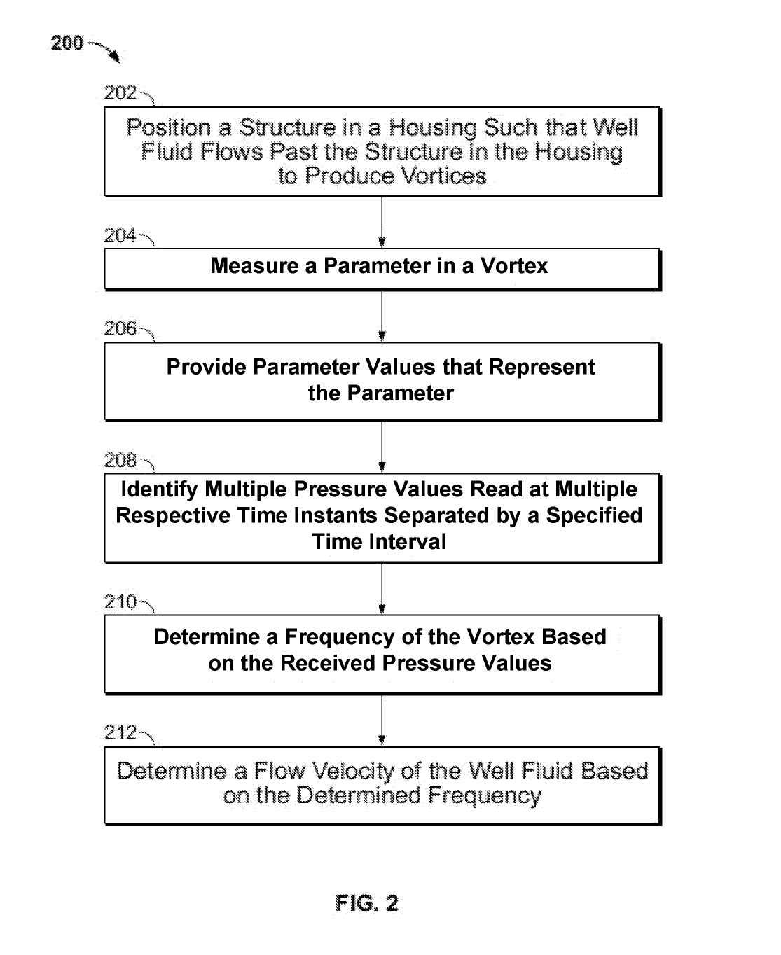

FIG. 1 illustrates an example well fluid flow velocity measurement system. In some implementations, the measurement system can be implemented outside a well 102 through which well fluid 104 is flowed. In some implementations, the measurement system can be implemented outside the well 102 to receive the well fluid 104 flowing out of the well 102. For example, the measurement system can be implemented outside of the well on the drilling rig or elsewhere to measure drilling fluid velocity supplied to a drill string or to measure returning drilling fluid velocity from the annulus from drilling operations (or both). In another example, the measurement system can be implemented outside of the well on the rig or elsewhere to measure a velocity (or velocities) of another fluid (or fluids), e.g., completion fluids, treatment fluids, other well fluids, or combinations of them, supplied into or out of the well. Alternatively, the measurement system can be implemented inside the well 102 to receive the well fluid 104 flowing through (either downhole or uphole) the well 102. For example, the measurement system can be mounted on a string of tubing (e.g., jointed and/or coiled) or carried on wire (e.g., wireline, slickline, e-line and/or other) into the well to measure flow velocity of fluids in the well. When used on tubing, the measurement system can be arranged to measure flow velocity in the tubing or in the annulus. As described below with reference to FIG. 2, the measurement system can generate vortices in the well fluid 104 that is flowed through the measurement system.

The measurement system can include a well fluid flow monitoring unit that includes a housing 106 with inner walls that define a well fluid flow path. A structure 108 is positioned within the housing 106 in a well fluid flow path to produce vortices. The vortices produced using the structure 108 can be asymmetric or symmetric. The well fluid flow monitoring unit can also include a vortex sensor 110 to determine a parameter of a well fluid flow generated in response to a vortex being produced in the well fluid 104 and to provide (e.g., transmit over hard wires or over a wired or wireless network) the parameter. The vortex sensor 110 can be positioned in the housing 106 and in the well fluid flow path.

In some implementations, the vortex sensor 110 can be positioned downstream relative to the structure 108 to determine a pressure in the vortex at the downstream position. For example, a position of the vortex sensor 110 downstream of the structure 108 can be such that vortices produced at a position on the structure flow past the vortex sensor 110 enabling the vortex sensor 110 to measure the pressure in the vortices. In such implementations, the vortex sensor 110 can provide a good signal-to-noise behavior of parameter values measured by the vortex sensor 110. In some implementations, the vortex sensor 110 need not be directly in the flow path of the vortices. Alternatively, the vortex sensor 110 can determine a pressure that is influenced by the generation of the vortices. Positioning the vortex sensor 110 out of the direct path of the vortex may be simpler relative to in the direct path of the vortex. Alternative or additional parameters that can be measured to determine a frequency of vortex shedding can include a force on the structure 108 at which the vortices are generated or vortex induced vibration (or combinations of them).

The measurement system can include a controller 114 of a computing system 112, which can include a computer-readable medium 116 to store computer instructions executable by the controller 114. In some implementations, the controller 114 can include a computer processor or a data processing apparatus that can execute the instructions stored in the computer-readable medium 116 to receive the parameter determined by the flow monitoring unit, determine a frequency of the vortices from the received parameter, and determine a flow velocity of the well fluid based on the determined frequency.

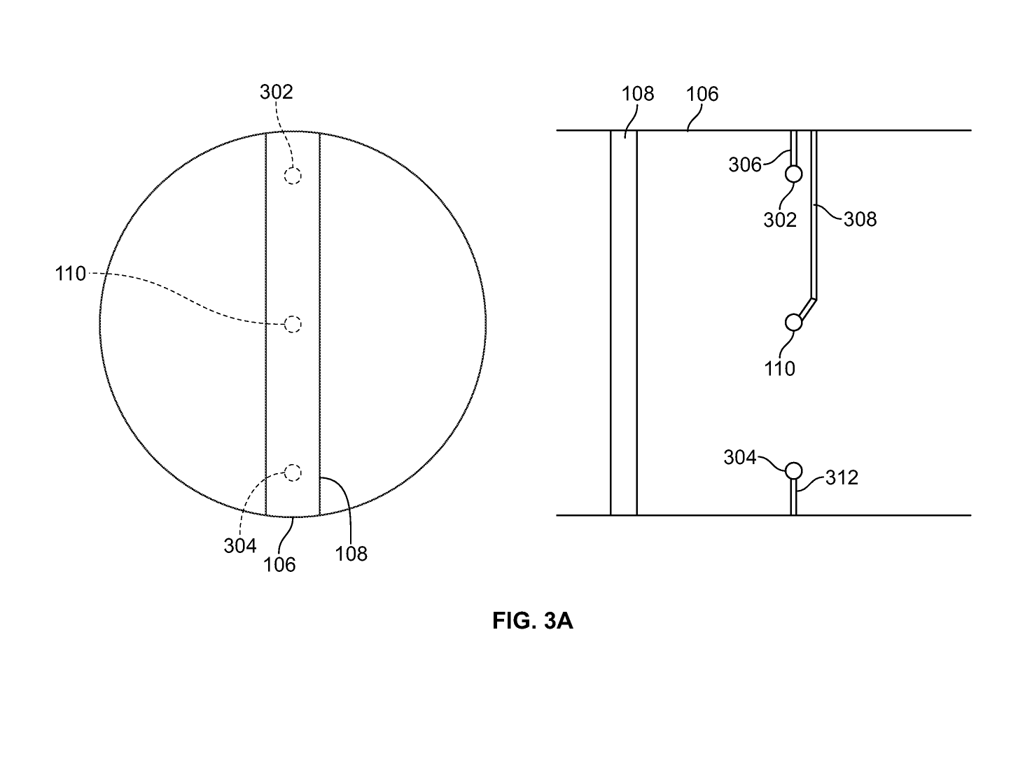

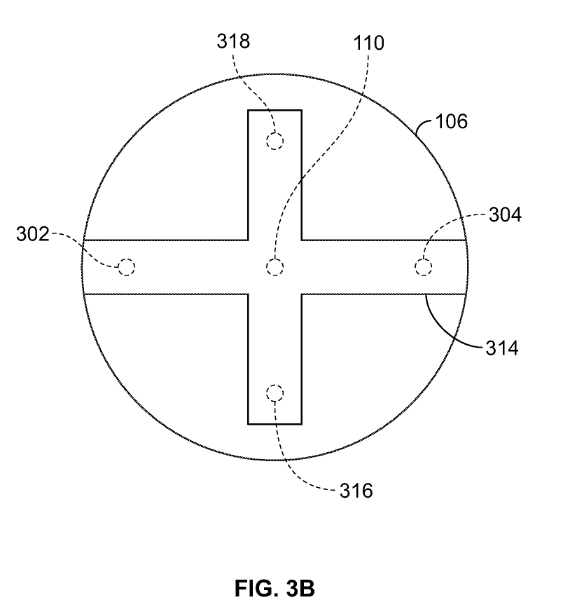

FIG. 2 is a flowchart of a process 200 for determining well fluid flow velocity using the well fluid flow velocity measurement system of FIG. 1. At 202, the structure 108 in the housing 106 is positioned such that the well fluid flows past the structure 108 in the housing 106 to produce vortices. In certain instances, the structure 108 is a solid cylinder made from a material (e.g., carbide and/or other material) that can withstand the well fluid properties, e.g., the well fluid particulate content, the well fluid density, chemical (or other) content, and also withstand the hostile operating conditions of the well 102. The structure 108 can be sufficiently rigid to not substantially bend in response to the force of the well fluid flowing past the structure. In some implementations, a bendability of the structure 108 can be sufficient to measure a force when a vortex is shed from the structure 108. For example, the structure 108 can bend to a first degree when the vortex is produced and to a second degree that is different from the first degree when the vortex is shed. In some implementations, the structure 108 can span an entire flow path, wall-to-wall, across the interior of the housing 106 (FIG. 3A), or, alternatively, can span less than the entire cross-section of the housing 106. As the well fluid flows past the structure 108, multiple vortices are generated, each at a respective position along a length of the structure 108. In some implementations, the structure 108 can be a feature of the housing 106 or the flow monitoring unit that extends into the well fluid flow path, and need not be a separate structure inserted in the well fluid flow path for the purpose of producing vortices.

At 204, the vortex sensor 110 measures a parameter of the well fluid flow that is affected by a vortex being generated at a position on the structure 108. In some implementations, the vortex sensor 110 can include any sensor (e.g., a pressure sensor or other sensor) that can be pressure coupled to the well fluid 104 and can withstand the operating conditions of the well 102. Without loss of generalization, a pressure-transferring cover can be placed over the pressure sensor in order to enable the pressure to be communicated to the sensor without direct contact between the well fluids and the sensor. In other embodiments, the pressure sensor can be in direct contact with the well fluid. For example, the vortex sensor 110 may not include rotating parts. In some implementations, the vortex sensor 110 can include, e.g., a pitot tube, a strain gauge-based and/or another type of pressure sensor.

In some implementations, the vortex sensor 110 can be attached to an end of (or can include) an elongate structure 111 such that the position of the vortex sensor 110 in the housing 106 is downstream from the position on the structure 108 at which the vortex is generated. The elongate structure 111 can be rigidly attached to the interior wall of the housing 106 and can extend into the flow with the vortex sensor 110 carried at or near its end. The elongate structure 111 can be made from a material that is sufficiently rigid not to substantively bend due to the force generated by the flow past the elongate structure 111. In this manner, the elongate structure 111 can support the vortex sensor 110 in a fixed location (i.e., fixed relative to the position on the structure 108 at which the vortex is generated) and in the vortex flow path. Sometimes, the position on the structure 108 at which the vortex is generated and the position of the vortex sensor 110 can be at or near the center of the flow path. In some implementations, the elongate structure 111 can be straight, while, in other implementations, the elongate structure 111 can be of a different shape, e.g., angular, curved or other non-straight shape. In general, the elongate structure 111 can have a shape and rigidity sufficient to position the vortex sensor 110 at a desired location in the flow path that does not change due to the flowing fluid. In some implementations, the vortex sensor 110 can be positioned at a center of the flow path to measure the flow velocity at the center. By locating the vortex sensor 110 at various locations along a cross-sectional dimension (e.g., the diameter) of the housing 106, pressures in multiple vortices, each produced at a different position on the structure 108 can be measured. Alternatively, pressures in the multiple vortices can be measured by positioning multiple vortex sensors 110, each downstream from a respective position on the structure 108 at which the vortex is produced. The vortex sensor 110 can continuously measure the vortex pressure as the vortex flows past the vortex sensor 110.

In some implementations, the vortex sensor 110 can measure a force on the structure 108 that is affected by the well fluid flowing past the structure 108. For example, a force on the structure 108 can change (e.g., decrease) when a vortex is shed from the structure 108. The vortex sensor 110 can continuously measure force values that represent the force on the structure 108 and provide the force values to the controller 114. In such implementations, the vortex sensor 110 can be mounted to the structure 108 that generates the vortices. The vortex sensor 110 can use other sensors that can sense (e.g., approximate) the pressure by noting the forces or motion on the structure 108. Such sensors can include, e.g., an accelerometer, a strain gauge, or other sensors to measure the motion of the relatively rigid structure 108. In some implementations, the vortex sensor 110 can use a stress sensor (e.g., a piezoelectric stress sensor, a magnetostrictor, or other stress sensor) to measure the forces on the structure 108. The pressures created by the vortex can create differential pressure on the vortex sensor 110. Such differential pressures can be measured by sensing the motion or the forces on the vortex sensor 110. As described above, the motion or forces on the vortex sensor 110 can be measured with a sensor, e.g., an accelerometer, a strain sensor, a piezoelectric, a magnetostrictor, other sensors (or combinations of them).

At 206, vortex sensor 110 can provide parameter values that represent the parameter to the controller 114. In some implementations, the controller 114 can be connected to the vortex sensor 110 (e.g., via hard wires or over a wired or wireless network) and can continuously receive multiple parameter values provided by the vortex sensor 110. The controller 114 can receive the parameter values, e.g., continuously, from the vortex sensor 110.

At 208, the controller 114 can identify the multiple parameter values at multiple respective time instants separated by a specified time interval. For example, the controller 114 can continuously receive the pressure values measured by the vortex sensor 110, e.g., as analog values. For example, at a first time instant (t₁), the controller 114 can read a first parameter value (p₁) from the vortex sensor 110. After the specified time interval has expired, at a second time instant (t₂), the controller 114 can read a second parameter value (p₂) from the vortex sensor 110. In this manner, the controller 114 can read multiple parameter values at respective multiple time instants, each separated by the specified time interval. The controller 114 can store, e.g., in the computer-readable medium 116, each parameter value and each time instant at which the parameter value was read. The controller 114 can store the multiple parameter values and the respective multiple time instants at which the parameter values were measured in the computer-readable medium 114. At the multiple time instants separated by the specified time interval, the controller 114 can convert respective multiple analog pressure values into digital pressure values, e.g., using an analog-to-digital converter (ADC), to determine the vortex shedding frequency.

At 210, the controller 114 can determine a frequency of the vortex based on the received parameter values. To determine the frequency of the vortex from the multiple parameter values, the controller 114 can determine that a first vortex has been shed from the structure 108. For example, the controller 114 can determine that the first vortex has been shed based, in part, on a change (e.g., a drop) in a pressure in the vortex, a change in a force on the structure 108, a change in a pressure in a portion of the well fluid that is not directly in the vortex flow path (or combinations of them). A number of vortices that shed in a given time (i.e., frequency of the vortices or frequency of vortex shedding) is determined from the measured pressure, and a flow velocity of the well fluid is determined from the determined frequency using, e.g., a controller of a computing system. The frequency of the vortices increases in direct proportion to fluid flow velocity and can be represented by the non-dimensional Strouhal number, St, as shown in Equation 1.

$$St = \frac{f \times d}{U} \qquad ( Equation 1 )$$

In Equation 1, f is the frequency of the vortex, d is the width of the structure, and U is the fluid flow velocity. Equation 1 can be rewritten as shown in Equation 2.

$$U = \frac{f \times d}{St} \qquad ( Equation 2 )$$

Vortex shedding also occurs in confined flow, e.g., flow through a housing such as a pipe as represented in Equation 3.

$$\overline{U} = \frac{f \times d}{{St}^{′}} \qquad ( Equation 3 )$$

In Equation 3, the fluid flow velocity term is replaced by an average fluid velocity term and the Strouhal number is replaced by the meter Strouhal number. The Strouhal number is also a function of Reynolds number, which changes with flow velocity. Therefore, the Strouhal number also changes as the flow velocity is changes. This relationship is pre-programmable, e.g., in the controller 114.

A K-factor, K, is defined for the flow through the housing based on a cross-sectional area, A, of the housing in which the fluid flow occurs and the volumetric flowrate, Q as shown in Equation 4.

Q=A×Ū (Equation 4)

From Equation (3),

$$Q = ( \frac{( A \times d )}{{St}^{′}} ) \times f \qquad ( Equation 5 )$$

The K-factor, K, is defined as shown in Equation 6.

$$K = \frac{{St}^{′}}{( A \times d )} \qquad ( Equation 6 )$$

Consequently, the volumetric flow rate is defined as shown in Equation 7.

$$Q = \frac{f}{K} \qquad ( Equation 7 )$$

In some implementations, some or all of the calculations described above can be performed by the controller 114. For example, one or more or all of the equations can be implemented as computer-readable instructions stored on the computer-readable medium 116 and executable by the controller 114. In some implementations, the controller 114 can implement digital data processing, e.g., Fast Fourier Transforms, on the received pressure values. Alternatively, or in addition, the controller 114 can implement a wavelet transform or analog data processing, e.g., band pass filtering on the received vortex sensor values, or combinations of them.

To determine that a vortex has been shed, the controller 114 can identify a minimum parameter value of the multiple parameter values received from the vortex sensor 110, and identify a time instant associated with the smallest parameter value. As described above, a vortex is determined to have been shed from the structure 108 when a pressure drop occurs in the vortex or when a force on the structure 108 changes or when a pressure in another portion of the well fluid changes (or combinations of them). In the example of the pressure drop in the vortex, the pressure in the vortex flowing past the vortex sensor 110 may not significantly change until the vortex has been shed. The minimum pressure value of the multiple pressure values can indicate vortex shedding. Sometimes, however, pressure drop can occur for other reasons, e.g., change in well fluid conditions such as well fluid density. The controller 114 can determine if a difference between the smallest pressure value and one or some or all of the remaining pressure values is significant. If the difference is significant, then the controller can determine that a vortex that passed the vortex sensor 110 at the identified time instant associated with the smallest pressure value has been shed. For example, the maximum and minimum values over an extended time period can be noted. Any values from the vortex sensor that are within a band of the maximum are considered to be near the peak and within a band of the minimum are considered to be near the trough. The controller 114 can similarly evaluate parameter values that represent a force on the structure 108.

The controller 114 can continue to request and receive multiple parameter values at multiple respective time instants from the vortex sensor 110. The controller 114 can repeat the operations described above to determine that a second vortex that has been shed from the structure 108. The controller 114 can determine the vortex frequency from a difference between a second time instant at which the second vortex was shed and a first time instant at which the first vortex was shed. The controller 114 can repeat these operations to identify multiple time instants at which multiple vortices have been shed. From these time instants, the controller 114 can determine a vortex frequency (i.e., a frequency at which the vortices are shed). For example, the controller 110 can determine the frequency from an average of times between the vortices being shed from the structure 108. This time average can be performed over multiple vortices in order to create a more accurate reading on the vortex shedding frequency.

At 212, the controller 114 can determine a flow velocity of the well fluid based on the determined frequency. To do so, in some implementations, the controller 114 can implement one or more of Equations 1-7 (described above) for determining well fluid flow velocity from the frequency of the vortex. As the well fluid flow velocity changes, the frequency with which the vortices shed also changes. Thus, by continuously measuring the parameters described above in the well fluid flow and determining the frequencies at which the vortices are shed, the well fluid flow velocity measurement system can determine changes in flow velocities over time. By implementing a flow monitoring unit without rotating or otherwise moving parts, the well fluid flow velocity measurement system is less susceptible to clogging.

In some implementations, the controller 114 can calibrate the flow monitoring unit prior to the flow monitoring unit determining the parameter as described above. Also, in some implementations, the controller 114 can provide the determined flow velocity to an output device, e.g., a display device connected to the computing system 112, a computer-readable storage device connected to the computing system 112, a computer software application executable (e.g., by the computing system 112) to perform operations based on receiving the frequency as an input or combinations of them.

The techniques described with reference to FIG. 2 can be implemented to determine a well fluid flow velocity in a portion of the well fluid. For example, FIG. 3A shows that the vortex sensor 110 is disposed downstream of the structure 108 at a position that is near a center of the housing 106. By implementing the techniques described above, the controller 114 can determine a well fluid flow velocity near the center of the housing 106. However, the well fluid flow velocity near the center of the housing 106 can be different from that near an inner surface of the housing. For example, under ideal conditions, if the well fluid flow is fully developed laminar flow, then the well fluid flow velocity will have a parabolic profile such that a well fluid flow velocity at the center of the housing 106 is a maximum and the velocity at the inner surface of the housing is a minimum.

In some implementations, the well fluid flow velocity measurement system can be implemented to determine a velocity profile of the well fluid flow flowing through the housing 106. To do so, multiple vortex sensors (e.g., a second vortex sensor 302, a third vortex sensor 304) can be positioned at respective positions along a cross-sectional dimension (e.g., a diameter) downstream from the structure 108. Each vortex sensor can be used to monitor a parameter that is affected by vortices formed at a position on the structure 108 that is upstream from the vortex sensor. The controller 114 can implement operations similar to those described above to determine a frequency at which each vortex is shed from the structure 108. From the multiple determined frequencies, the controller 114 can determine multiple flow velocities at respective different positions in the well fluid along the cross-sectional dimension of the housing 106. Each flow velocity is associated with a position on the structure 108 at which a vortex was produced. The flow velocities determined at the different positions in the well fluid can be used to generate a flow velocity profile of the well fluid.

For example, FIG. 3A illustrates that the structure 108 spans the entire flow path in the interior of the housing 106. The measurement system can be implemented to measure parameters in a vortex that spans across the flow path using three vortex sensors. A first portion of the vortex is produced by the structure 108 near an inner wall of the housing 106. Pressure in the first portion is measured using a first vortex sensor 302 mounted on a first elongate structure 306 that is downstream of the structure 108. A second portion of the vortex is produced by the structure 108 at or near a center of the flow path. Pressure in the second portion is measured using the vortex sensor 110 mounted on a second elongate structure 308 that is downstream of the structure 108. A third portion of the vortex is produced by the structure 108 near an inner wall of the housing 106 that is diametrically opposite to a location of the first vortex. Pressure in the third portion is measured using a third vortex sensor 304 mounted on a third elongate structure 312 that is downstream of the structure 108 The three elongate structures 306, 308 and 312 can be rigidly connected to the housing 106 such that the three vortex sensors 302, 110 and 304 are equidistant from the structure 108. Additional vortex sensors can be mounted to additional elongate structures to measure pressures in additional portions of the vortex produced in other locations on the structure 108. In this manner, the measurement system can be implemented to measure flow velocities along an inner diameter of the housing 106. The measured flow velocities can be used to develop a two-dimensional flow velocity profile for the fluid. The two-dimensional flow velocity profile can similarly be determined by measuring parameters other than pressure such as the parameters described above.

In some implementations, a three-dimensional flow velocity profile of the well fluid can be generated by implementing a structure 310, a side-view of which is shown in FIG. 3B. The structure 310 can be implemented to generate a vortex with multiple portions at multiple locations in the flow path. For example, the structure 310 can be implemented to generate the vortex with multiple portions (e.g., two, three or more portions) along a first inner diameter of the housing 106, and multiple portions (e.g., two, three or more portions) along a second inner diameter of the housing 106 that is perpendicular to the first inner diameter. Similarly to the vortex sensors described with reference to FIG. 3A, multiple vortex sensors (e.g., a vortex sensor 314, a vortex sensor 316, a vortex sensor 318, and other vortex sensors) can be mounted downstream of the structure 310 on respective elongate structures or at different positions on the same elongate structure. As described above, the elongate structure (or structures) on which the multiple vortex sensors are mounted can be rigidly attached to an inner wall of the housing 106 such that the vortex sensors are equidistant from the structure from which the vortex is produced. The measurement system can be implemented to measure flow velocities at different positions in a cross-section of the flow-path. The multiple flow velocities can be used to develop a three-dimensional flow velocity profile for the fluid. Moreover, a flow velocity profile over time can also be determined using the techniques described here. Similarly to the two-dimensional flow velocity profile, the three-dimensional flow velocity profile and time-varying flow velocity profile can be determined by measuring parameters other than pressure such as the parameters described above.

A number of implementations have been described. Nevertheless, it will be understood that various modifications may be made without departing from the spirit and scope of the disclosure.

1. A well fluid flow velocity measurement system, the system comprising:
a well fluid flow monitoring unit to:
determine a parameter of a well fluid flow affected by a vortex being produced in a well fluid; and
provide the parameter; and
a controller to:
receive the parameter determined by the flow monitoring unit;
determine a frequency of the vortex from the received parameter; and
determine a flow velocity of the well fluid based on the determined frequency.

2. The system of claim 1, wherein the flow monitoring unit comprises:
a housing;
a structure in the housing positioned in a well fluid flow path to produce vortices; and
a vortex sensor in the housing and in the well fluid flow path downstream relative to the structure.

3. The system of claim 2, wherein the vortex sensor comprises a pressure sensor which comprises a pitot tube or a strain gauge based pressure sensor.

4. The system of claim 2, wherein the controller is further provided to:
identify a plurality of parameter values determined by the vortex sensor at a respective plurality of time instants separated by the specified time interval;
receive the plurality of parameter values determined at the respective plurality of time instants from the flow monitoring unit; and
determine the frequency of the vortex from the plurality of parameter values.

5. The system of claim 4, wherein, to determine the frequency of the vortex from the plurality of parameter values, the controller is further provided to:
identify a minimum parameter value of the plurality of parameter values;
identify a time instant of the plurality of time instants associated with the minimum parameter value; and
determine that a vortex passed the pressure sensor at the identified time instant.

6. The system of claim 2, further comprising:
a structure positioned in the well fluid flow path to produce a vortex that spans a plurality of positions on the structure along a direction transverse to the well fluid flow path, the vortex comprising a plurality of vortex portions, each vortex portion produced at a respective position on the structure; and
a plurality of vortex sensors in the housing and in the well fluid flow path, each vortex sensor to measure a parameter in each vortex portion of the plurality of vortex portions.

7. The system of claim 6, wherein the controller is further provided to:
receive a plurality of parameter values from the plurality of vortex sensors, each parameter value being a parameter in a vortex determined by each vortex sensor;
determine a plurality of frequencies of the plurality of vortex portions; and
determine a plurality of flow velocities of the well fluid based on the determined plurality of frequencies, each flow velocity being associated with a position on the structure at which a vortex portion of the plurality of vortex portion was produced.

8. The system of claim 1, wherein the parameter of the well fluid flow is a force on a structure in the housing positioned in a well fluid flow path to produce vortices in response to the well fluid flowing past the structure, and wherein the system further comprises a vortex sensor to measure the force on the structure.

9. The system of claim 1, wherein the parameter of the well fluid flow is a pressure in the vortex downstream of a position in the well fluid flow path at which the vortex is produced.

10. The system of claim 1, wherein the controller is further provided to calibrate the flow monitoring unit prior to the flow monitoring unit determining the parameter of the well fluid flow affected by the vortex.

11. The system of claim 1, wherein the flow monitoring unit is void of moving parts.

12. The system of claim 1, wherein the well fluid comprises drilling mud or a produced fluid.

13. A method for measuring flow velocity of a well fluid flowing through a well, the method comprising:
producing a vortex in a well fluid;
measuring a parameter of the well fluid, wherein the parameter is affected by the produced vortex;
determining, with a processor of a computing system, a frequency of the vortex based on the measured parameter; and
determining, with the processor, a flow velocity of the well fluid based on the determined frequency.

14. The method of claim 13, wherein the measured parameter is pressure measured at a position downstream of a position in the well fluid at which the vortex is produced.

15. The method of claim 14, wherein producing the vortex in the well fluid comprises positioning a structure in a housing such that the well fluid flows past the structure in the housing, the method further comprising measuring the pressure downstream relative to the structure.

16. The method of claim 15, wherein the pressure comprises a force on the structure in response to the well fluid flowing past the structure.

17. The method of claim 13, wherein measuring the parameter comprises:
receiving the parameter from a vortex sensor; and
in response to receiving the parameter from the vortex sensor, periodically identifying a plurality of parameter values at a respective plurality of time instants separated by a specified time interval.

18. The method of claim 17, wherein determining a frequency of the vortex based on the measured parameter comprises:
identifying a minimum parameter value of the plurality of parameter values;
identifying a time instant of the plurality of time instants associated with the minimum pressure value; and
determining that a vortex passed the vortex sensor at the identified time instant.

19. The method of claim 13, further comprising calibrating a determination of the frequency of the vortex prior to determining the flow velocity.

20. A well fluid flow velocity measurement system, the system comprising:
a housing:
a structure in the housing positioned in a well fluid flow path to produce a vortex comprising a plurality of vortex portions, wherein each vortex portion is produced at a respective position on the structure;
a vortex sensor in the housing and in the well fluid flow path, wherein the vortex sensor measures a plurality of parameter values, each parameter value representing a parameter affected by the vortex, each parameter value at a respective position on the structure at which a vortex portion is produced; and
a controller to:
determine a plurality of frequencies of the plurality of vortex portions based on the plurality of parameter values; and
determine a flow velocity profile of the well fluid based on the determined plurality of frequencies.
